(19) United States
(12) Patent Application Publication
(10) Pub. No.: US 2009/0146791 A1
(43) Pub. Date: Jun. 11, 2009

(54) Method, device, and system for "listen-before-talk" measurement to enable identifying of one or more unoccupied RF sub-bands

(75) Inventors: Joni Jantunen, Helsinki (FI); Hannu Laine, Helsinki (FI); Antti Lappetelainen, Espoo (FI); Sassan Iraji, Espoo (FI)

Correspondence Address: HARRINGTON & SMITH, PC, 4 RESEARCH DRIVE, Suite 202, SHELTON, CT, 06484-6212, US

(73) Assignee: NOKIA CORPORATION, Espoo (FI)

(21) Appl. No.: 11/990,523

(22) PCT Filed: Nov. 24, 2005
(86) PCT No.: PCT/IB2005/003539

§ 371 Date: Feb. 14, 2008

(51) Int. Cl. H04Q 5/22

(52) U.S. Cl. 340/10.2; 455/41.2; 455/62

(57) ABSTRACT

The invention relates to a method of performing a Listen-Before-Talk measurement to enable identifying of one or more unoccupied radio frequency sub-bands applicable for radio frequency identification (RFID) communication operable with a radio frequency identification (RFID) reader subsystem; said method including obtaining timing information relating to one or more periods of activity of a wireless communication subsystem; deriving information about one or more periods of non-activity from said timing information; configuring said wireless communication subsystem to perform said Listen-Before-Talk measurement in coordination with said one or more periods of non-activity; and performing said Listen-Before-Talk measurement by the means of the wireless communication subsystem to identify said one or more unoccupied radio frequency sub-bands.

The present invention relates to short-range communication systems. Particularly the present invention relates to radio frequency identification (RFID) communication technology.

Radio frequency identification (RFID) technology relates basically to the field of local communication technology and more particularly local communication technology involving electromagnetic and/or electrostatic coupling technology. Electromagnetic and/or electrostatic coupling is implemented in the radio frequency (RF) portion of the electromagnetic spectrum, using for example radio frequency identification (RFID) technology, which primarily includes radio frequency identification (RFID) transponders also denoted as radio frequency identification (RFID) tags and radio frequency identification (RFID) reader interfaces for radio frequency transponders also denoted for simplicity as radio frequency identification (RFID) readers.

In the near future, an increasing amount of different radio technologies will be integrated to mobile terminals. Expanding range of different applications drives need and requirement to provide radio access methodologies with different data rate, range, robustness, and performance specifically adapted to application environments and use cases, respectively. As a consequence to the multi-radio scenarios problems in interoperability of the multi-radio enabled mobile terminals will become a challenge in development.

Radio frequency identification (RFID) technology is one of the recent arrivals in the terminal integration. radio frequency identification (RFID) communication enables new usage paradigms, e.g. pairing of devices, exchanging security keys, or obtaining product information by touching items provided with radio frequency identification (RFID) tags with radio frequency identification (RFID) communication enabled terminal. Typically, the operation range between the radio frequency identification (RFID) tag and radio frequency identification (RFID) reader interface in consumer applications is considered to be only a few centimeters.

Actually, there have already been product releases in radio frequency identification (RFID) readers integrated in mobile phones. Current implementations are based on Near Field Communications (NFC) technology that operates on 13.56 MHz. The communication in that technology is obtained by inductive coupling and therefore it requires rather large coil antennas both in the reader and tag. Furthermore, inductive coupling has its limitations when it comes to the range of the radio connection. Typically the maximum range at 13.56 MHz with reasonable excitation current and antenna sizes is about 1 m to 2 m.

The limited range of radio frequency identification (RFID) systems at 13.56 MHz has increased the interest in supply chain management and logistics application arena towards higher frequencies, namely UHF (ultra high frequency) from 860 MHz to 960 MHz and microwave frequencies at the 2.4 GHZ ISM frequency band. At UH frequencies (around 868 MHz in Europe and 915 MHz in United States in accordance with the frequency allocation) the achievable range in industrial and professional fixed installations is up to ten meters, which allows completely new applications compared to 13.56 MHz. The operation of radio frequency identification (RFID) communication at UHF and microwave frequencies is based on backscattering, i.e. the radio frequency identification (RFID) reader (or interrogator) generates an excitation/interrogation signal and the radio frequency identification (RFID) transponder (or radio frequency identification (RFID) tag) alters its antenna impedance according to a specified, data dependent pattern.

Currently, the most significant standardization forum at the UHF band is the EPCglobal that is leading the development of industry-driven standards for the Electronic Product Code (EPC) to support the use of Radio Frequency Identification (RFID) technology in today's fast-moving, information rich trading networks. The shorter-term target is to replace bar codes in pallets, and in long term also in packages and some individual products. If those targets come true, users will get product information or pointers to more detailed information just by touching an item, e.g. provided with an EPCglobal conform radio frequency identification (RFID) transponder, to its radio frequency identification (RFID) communication enabled terminal.

The excitation power generated in a radio frequency identification (RFID) reader subsystem is reasonably high, from about 100 mW of consumer applications related to mobile terminal to several watts (e.g. maximal 2 W in accordance with ETSI regulations) used in professional fixed applications. The used frequency allocations for UHF radio frequency identification (RFID) band are the 868 MHz ISM band in Europe and the 915 MHz band in United States.

Whereas the FCC (Federal Communications Commission) Regulations of the United States requires the implementation of Frequency Hopping Spread Spectrum (FHSS) scheme for using Radio Frequency Identification (RFID) reader and transponder at the frequency range from 902 MHz to 928 MHz, the ETSI (European Telecommunications Standards Institute) regulations concerning the use of Radio Frequency Identification (RFID) reader and transponder at the frequency range from 965 MHz to 968 MHz presupposes a so-called “Listen-Before-Talk” (LBT) scheme in order to detect whether a distinct frequency sub-band intended for Radio Frequency Identification (RFID) communication is currently occupied or free (unoccupied). According to ETSI specifications, immediately prior to each communication by a Radio Frequency Identification (RFID) reader, the Radio Frequency Identification (RFID) reader has to be switched into listen mode and a pre-selected frequency sub-band is monitored for a specific listening period of time. The listening period of time should comprise a fixed time interval of 5 ms and a random time interval in the time range from 0 ms to r ms. In case the sub-band is free (unoccupied), the random time interval is set to 0 ms. The ETSI specifications further define certain minimum permitted levels for threshold levels, which define sensitivity characteristics. These sensitivity characteristics have at least to be achieved by the RF interface logic of a Radio Frequency Identification (RFID) reader at power level measurements of received RF signals to fulfill the aforementioned requirements in accordance with the “Listen-Before-Talk” (LBT) scheme.

Those skilled in the art will appreciate that the realization and implementation of a high RF signal sensitive RF interface into a Radio Frequency Identification (RFID) reader requires development efforts and is cost intensive due to the requirement of high quality RF components.

An object of the present invention is to overcome the aforementioned disadvantages in the state of the art. In particular, an object of the invention is to provide a economic solution being based on components and module typically implemented in modern terminal devices.

The object of the present invention is solved by the features of the accompanying independent claims.

According to an aspect of the present invention, a method is provided, which enables performing a Listen-Before-Talk measurement to allow identifying of one or more unoccupied RF sub-bands applicable for radio frequency identification (RFID) communication operable with a radio frequency identification (RFID) reader subsystem. timing information relating to one or more periods of activity of a wireless communication subsystem is obtained therefrom. information about one or more periods of non-activity is derived from the obtained timing information. The wireless communication subsystem is configured to perform the Listen-Before-Talk measurement in coordination with the one or more periods of non-activity and the Listen-Before-Talk measurement is performed by the means of the wireless communication subsystem to identify the one or more unoccupied RF sub-bands.

According to another aspect of the present invention, a computer program product is provided, which enables Listen-Before-Talk measurement to allow identifying of one or more unoccupied RF sub-bands applicable for radio frequency identification (RFID) communication operable with a radio frequency identification (RFID) reader subsystem. The computer program product comprises program code sections for carrying out the steps of the method according to an aforementioned embodiment of the invention, when the program is run on a computer, a terminal, a network device, a mobile terminal, a mobile communication enabled terminal or an application specific integrated circuit. Alternatively, an application specific integrated circuit (ASIC) may implement one or more instructions that are adapted to realize the aforementioned steps of the method of an aforementioned embodiment of the invention, i.e. equivalent with the aforementioned computer program product.

According to another aspect of the present invention, a controlling module is provided to enable Listen-Before-Talk measurement to allow identifying of one or more unoccupied RF sub-bands applicable for radio frequency identification (RFID) communication operable with a radio frequency identification (RFID) reader subsystem. The controlling module is operable to exercise control over a wireless communication subsystem and the radio frequency identification (RFID) reader subsystem. The controlling module is arranged for obtaining timing information relating to one or more periods of activity of the wireless communication subsystem therefrom. Further, the controlling module is configured to derive information about one or more periods of non-activity from the obtained timing information and the controlling module is arranged for configuring the wireless communication subsystem to perform the Listen-Before-Talk measurement in coordination with the one or more periods of non-activity. The controlling module is adapted to instruct the wireless communication subsystem to perform the Listen-Before-Talk measurement to identify the one or more unoccupied RF sub-bands.

According to another aspect of the present invention, a terminal device is provided, which is enabled for Listen-Before-Talk measurement to allow identifying of one or more unoccupied RF sub-bands applicable for radio frequency identification (RFID) communication operable with a radio frequency identification (RFID) reader subsystem. The terminal device comprises at least a wireless communication subsystem and the radio frequency identification (RFID) reader subsystem and a controlling module is provided, which is operable to exercise control over a wireless communication subsystem and the radio frequency identification (RFID) reader subsystem. The controlling module is arranged for obtaining timing information relating to one or more periods of activity of the wireless communication subsystem therefrom and the controlling module is configured to derive information about one or more periods of non-activity from the timing information. The controlling module is also arranged for configuring the wireless communication subsystem to perform the Listen-Before-Talk measurement in coordination with the one or more periods of non-activity. Further, the controlling module is adapted to instruct the wireless communication subsystem to perform the Listen-Before-Talk measurement to identify the one or more unoccupied RF sub-bands.

According to another aspect of the present invention, a system is provided, which enables Listen-Before-Talk measurement to allow identifying of one or more unoccupied RF sub-bands applicable for radio frequency identification (RFID) communication operable with a radio frequency identification (RFID) reader subsystem. The system comprises at least a wireless communication subsystem and the radio frequency identification (RFID) reader subsystem. A controlling module of the system is provided, which is operable to exercise control over a wireless communication subsystem and the radio frequency identification (RFID) reader subsystem. The controlling module is arranged for obtaining timing information relating to one or more periods of activity of the wireless communication subsystem therefrom and the controlling module is configured to derive information about one or more periods of non-activity from the timing information. The controlling module is also arranged for configuring the wireless communication subsystem to perform the Listen-Before-Talk measurement in coordination with the one or more periods of non-activity. Further, the controlling module is adapted to instruct the wireless communication subsystem to perform the Listen-Before-Talk measurement to identify the one or more unoccupied RF sub-bands.

For a better understanding of the present invention and to understand how the same may be brought into effect reference will now be made, by way of illustration only, to the accompanying drawings, in which:

FIG. 1 illustrates schematically principle block diagrams depicting typical components of a radio frequency identification (RFID) transponder and a radio frequency identification (RFID) reader subsystem;

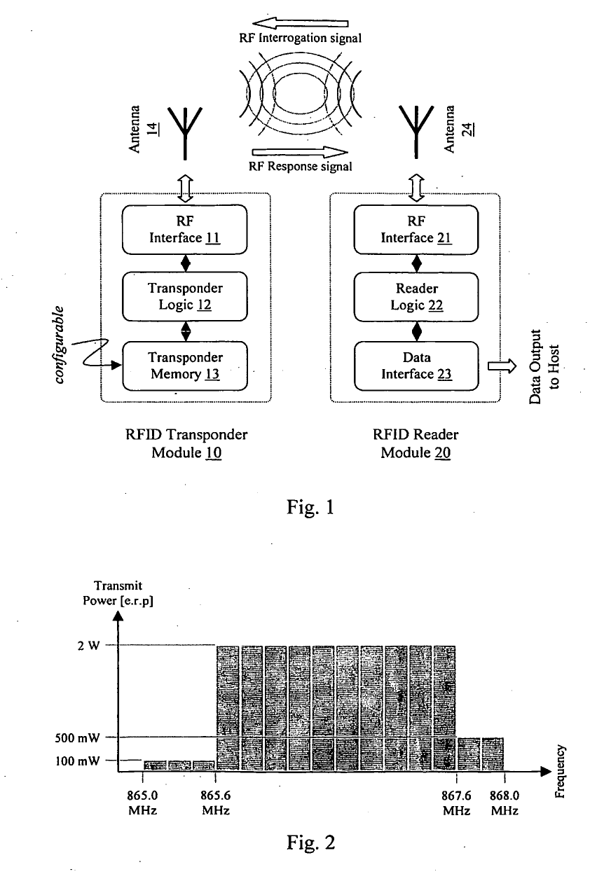

FIG. 2 illustrates schematically a frequency allocation diagram in accordance with the ETSI (European Telecommunications Standards Institute) EN 302 308 Regulation;

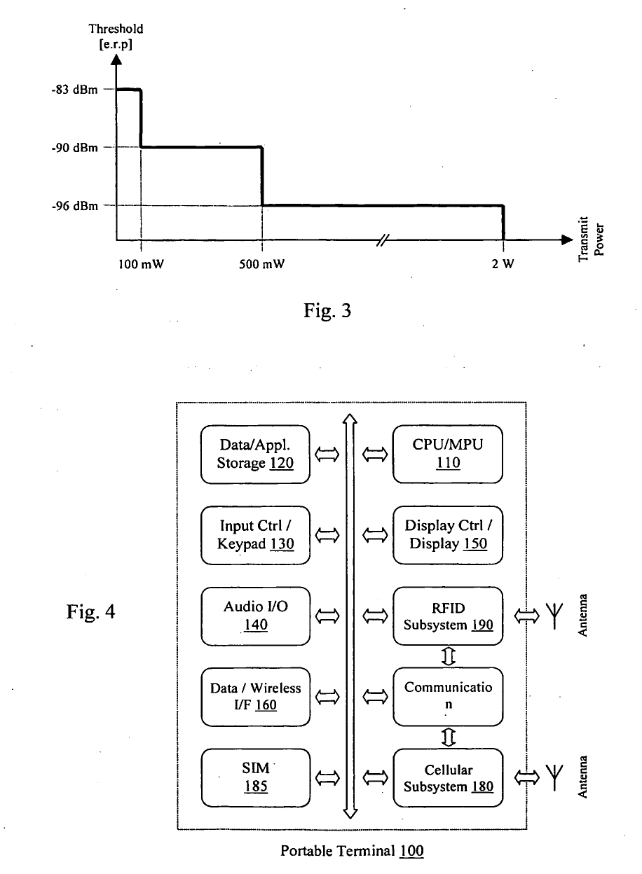

FIG. 3 illustrates schematically a principle block diagram of a portable cellular terminal enabled for radio frequency identification (RFID) communication according to an embodiment of the present invention;

FIG. 4 illustrates schematically receiver threshold levels in accordance with the frequency allocation conform to ETSI EN 302 308 Regulation;

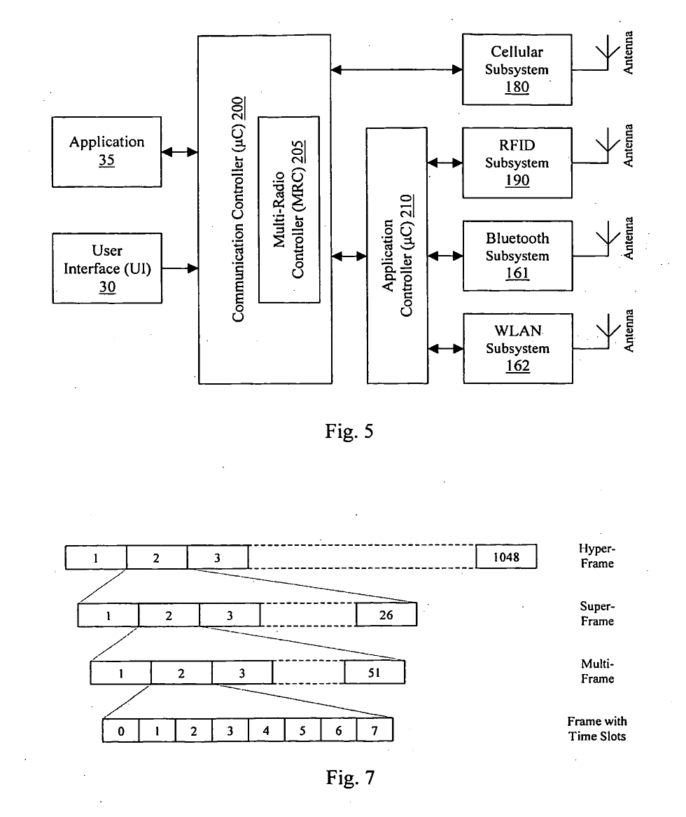

FIG. 5 illustrates schematically a further principle block diagram of the portable cellular terminal enabled for radio frequency identification (RFID) communication according to an embodiment of the present invention;

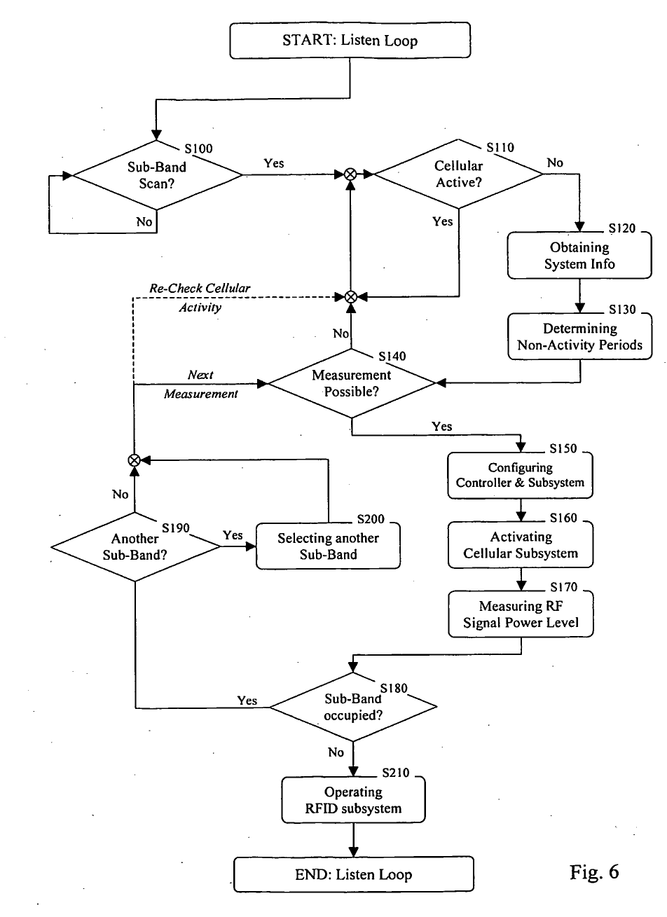

FIG. 6 illustrates schematically an operational sequence applicable to a Listen-Before-Talk (LBT) mechanism according to an embodiment of the present invention; and

FIG. 7 illustrates schematically a frame structure in accordance with GSM (Global System for Mobile Communication) Standard.

Throughout the description below, same and/or equal components will be referred by the same reference numerals.

In the flowing, the concept of the present invention will be described with reference to a cellular communication subsystem, which in particular supports GSM, GSM/GPRS, and/or GSM/EDGE, cellular communication. Moreover, the radio frequency identification (RFID) communication will be described with reference to Ultra-High Frequency (UHF) radio frequency identification (RFID) communication, which in particular supports EPCglobal standard. It should be noted that the aforementioned specifications of the cellular communication subsystem as well as the radio frequency identification (RFID) reader subsystem are given for the sake of illustration. The invention should be understood as not being limited thereto.

Originally, radio frequency identification (RFID) technology has been developed and introduced for electronic article surveillance, article management purposes, and logistics primarily for replacing bar code identification labels, which are used for article management purposes and logistics up to now. A typical implementation of a state of the art radio frequency identification (RFID) transponder is shown with respect to FIG. 1. A typical radio frequency identification (RFID) transponder module 10 includes conventionally an electronic circuit, depicted exemplary as transponder logic 12, with data storage capacity, depicted herein as transponder memory 13, and a radio frequency (RF) interface 11, which couples an antenna 14 to the transponder logic 12 The radio frequency identification (RFID) transponders are typically accommodated in small containers, particularly mounted to the item to be tagged by the means of adhesive. Depending on the requirements made on envisaged applications of the radio frequency identification (RFID) transponders (i.e. the data transmission rate, energy of the interrogation, transmission range etc.) different types are provided for data/information transmission at different radio frequencies within a range from several 10-100 kHz to some GHz.

In particular, currently following typical frequencies are used for radio frequency identification (RFID) technology:
Low frequency range at less that 135 kHz, typically around 125 kHz;
High frequency range at around 13.57 MHz;
Ultra-High Frequency range (UHF) at 860 MHz to 960 MHz; and
Microwave frequency range at 2.54 GHz ISM frequency band.

Among the above identified frequency ranges, the UHF range is the most interesting operational frequency range. Communication at the UHF range typically offers better coverage ranges (up to approximately 5 m or even 10 m at optimal conditions) and enable higher communication data rates. Inter alia, radio frequency identification (RFID) at UHF range is conventionally operable with Electronic Product Codes (EPC) in accordance with EPCglobal specification primarily applicable in production chain management. It is expected that such EPCglobal conform radio frequency identification (RFID) transponders will be the dominant types of radio frequency identification (RFID) transponders in future. A brief summary of the communication requirements and protocol in accordance with EPCglobal specifications will be given below.

Two main classes of radio frequency identification (RFID) transponders can be distinguished. Passive radio frequency identification (RFID) transponders are activated and energized by radio frequency identification (RFID) readers, which generate an excitation or interrogation signal, for example a radio frequency (RF) signal at a predefined frequency. Active radio frequency identification (RFID) transponders comprise their own power supplies (not shown) such as batteries or accumulators for energizing.

Upon activation of a radio frequency identification (RFID) transponder by the means of a radio frequency identification (RFID) reader module 20, the informational contents stored in the transponder memory 13 are modulated onto a radio frequency (RF) signal (i.e. the interrogation RF signal), which is emitted by the antenna 14 of the radio frequency identification (RFID) transponder module 10 to be detected and received by the radio frequency identification (RFID) reader module 20. More particularly, in the case of a passive radio frequency identification (RFID) transponder (i.e., without local power source), the radio frequency identification (RFID) transponder module 10 is conventionally energized by a time-varying electromagnetic radio frequency (RF) signal/wave generated by the interrogating radio frequency identification (RFID) reader. When the radio frequency (RF) field passes through the antenna coil associated with the radio frequency identification (RFID) transponder module 10, a voltage is generated across the coil. This voltage is used to energize the radio frequency identification (RFID) transponder module 10, and enables back transmission of information from the radio frequency identification (RFID) transponder module 10 to the radio frequency identification (RFID) reader module 20, which is sometimes referred to as back-scattering.

Typical state of the art radio frequency identification (RFID) transponders correspond to radio frequency identification (RFID) standards such as the ISO 14443 type A standard, the Mifare standard, Near Field Communication (NFC) standard, and/or the EPCglobal standard.

In accordance with the application purpose of a radio frequency identification (RFID) transponder, the information or data stored in the transponder memory 13 may be either hard-coded or soft-coded. Hard-coded means that the information or data stored in the transponder memory 13 is predetermined and unmodifiable. Soft-coded means that the information or data stored in the transponder memory 13 is configurable by an external entity. The configuration of the transponder memory 13 may be performed by a radio frequency (RF) signal received via the antenna 14 or may be performed via a configuration interface (not shown), which allows access to the transponder memory 13.

A frequency identification (RFID) reader module 20 typically comprises a RF interface 21, a reader logic 22, and a data interface 23. The data interface 23 is conventionally connected with a host system such as a portable terminal, which, inter alia, on the one hand exercises control over the operation of the frequency identification (RFID) reader 20 by the means of instructions transmitted from the host to the reader logic 22 via the data interface 23 and on the other hand receives data provided by the reader logic 22 via the data interface 23. Upon instruction to operate, the reader logic 22 initiates the RF interface 21 to generate the excitation/interrogation signal to be emitted via the antenna 24 coupled to the RF interface 21 of the frequency identification (RFID) reader module 20. In case that a frequency identification (RFID) transponder such as frequency identification (RFID) transponder module 10 is within the coverage area of the excitation/interrogation signal, the frequency identification (RFID) transponder module 10 is energized and a modulated RF signal (back-scatter RF signal) is received therefrom. Particularly, the modulated RF signal carries the data stored in the transponder memory 13 modulated onto the excitation/interrogation RF signal. The modulated RF signal is coupled into the antenna 24, demodulated by the RF interface 21, and supplied to the reader logic 22, which is then responsible to obtain the data from the demodulated signal. Finally the data obtained from the received modulated RF signal is provided via the data interface of the frequency identification (RFID) reader module 20 to the host system connected thereto.

The communication between radio frequency identification (RFID) reader and radio frequency identification (RFID) transponder may occur in a simple response generated by the radio frequency identification (RFID) transponder upon interrogation by the radio frequency identification (RFID) reader. In a more sophisticated manner, the communication between radio frequency identification (RFID) reader and radio frequency identification (RFID) transponder may occur in a packetized manner where a single packet contains a complete command from the radio frequency identification (RFID) reader and a complete response from the radio frequency identification (RFID) transponder. The command and response permit half-duplex communication between the radio frequency identification (RFID) reader and radio frequency identification (RFID) transponder.

The EPCglobal specification represents a radio frequency identification (RFID) protocol of the latter described radio frequency identification (RFID) communication. Illustratively, the radio frequency identification (RFID) reader is enabled sending information to one or more radio frequency identification (RFID) transponders by modulating a RF carrier (continuous wave (CW); i.e. an interrogation or excitation RF signal) using double-sideband amplitude shift keying (DSB-ASK), single-sideband amplitude shift keying (SSB-ASK) or phase-reversal amplitude shift keying (PR-ASK) using a pulse-interval encoding (PIE) format. The radio frequency identification (RFID) transponders are arranged to receive their operating energy from this same modulated RF carrier. The radio frequency identification (RFID) reader is further arranged to receive information from a radio frequency identification (RFID) transponder by transmitting an unmodulated RF carrier (continuous wave (CW); interrogation or excitation RF signal) and listening for a backscattered response. Radio frequency identification (RFID) transponders communicate information by backscatter-modulating the amplitude and/or phase of the RF carrier. The encoding format, selected in response to radio frequency identification (RFID) reader commands, is for example either FM0 or Miller-modulated subcarrier. The communications link between a radio frequency identification (RFID) reader and radio frequency identification (RFID) transponder is half-duplex, meaning that radio frequency identification (RFID) transponder should not be required to demodulate radio frequency identification (RFID) reader subsystem commands while backscattering.

In accordance with the EPCglobal specifications, the radio frequency identification (RFID) reader is enabled to manage a population of radio frequency identification (RFID) transponders on the basis of three basic processes, which comprises in turn one or more process specific commands. A Select process is provided for choosing a population of radio frequency identification (RFID) transponders for subsequent communication, in particular Inventory and Access process command communication. A Select command may be applied successively to select a particular population of radio frequency identification (RFID) transponders based on user-specified criteria. This operation can be seen as analog to selecting one or more records from a database. An Inventory process is provided fro identifying radio frequency identification (RFID) transponders, i.e. for identifying radio frequency identification (RFID) transponders out of the population chosen by the means of the Select command. A radio frequency identification (RFID) reader may begin an inventory round, i.e. one or more inventory command and transponder response cycles, by transmitting a Query command in one of four sessions. One or more radio frequency identification (RFID) transponders may reply. The radio frequency identification (RFID) reader is enabled detecting a single radio frequency identification (RFID) transponders reply and requesting PC (Protocol Control bits), EPC (Electronic Product Code), and CRC (Cyclic Redundancy Code). from the detected radio frequency identification (RFID) transponder. Inventory process may comprise multiple inventory commands. An inventory round operates in one session at a time. An Access process is provided for communicating with a radio frequency identification (RFID) transponder, where the communication comprises especially reading from and/or writing to the radio frequency identification (RFID) transponder. An individual radio frequency identification (RFID) transponders should be uniquely identified prior to the Access process. The Access process may comprise multiple access commands, some of which employ one-time-pad based cover-coding of the Reader to Transponder communication link.

The radio frequency allocation is under the control of governmental administrations. Due to existing radio frequency allocations, different frequency regulatory standards are valid over the world. With respect to UHF RFID, the principle allocations for radio frequency identification (RFID) communication in USA (from 902 MHz to 928 MHz) are used in may countries including the United Kingdom, for cellular telephony and therefore the use for radio frequency identification (RFID) communication is not permitted. With respect to the UHF allocation for radio frequency identification (RFID) communication in the ITU (International Telecommunication Union) Region 1, which includes the ETSI (European Telecommunications Standards Institute) countries including all of Europe, but also Middle East, Africa, and the former Soviet Union, the frequency range from 865.0 MHz to 868.0 MHz has been allocated. Especially in view of the European countries, two ETSI technical standards are relevant in the aforementioned frequency range the EN (European Norm) 203 208 and EN 302 200. Inter alia, the cited European Norms define 15 channels each having a RF band width of 200 kHz within the frequency range from 865.0 MHz to 868.0 MHz.

With reference to FIG. 2, the different RF channels are illustrated against their maximum effective radiated power (ERP) levels defined by the ETSI technical standards. Within the frequency range from 865.0 MHz to 865.6 MHz, three RF channels at a band width of 200 kHz are specified, which maximum level of effective radiated power (ERP) is restricted to 100 mW, within the frequency range from 865.6 MHz to 867.6 MHz, ten RF channels at a band width of 200 kHz are specified, which maximum level of effective radiated power (ERP) is restricted to 2 W, and within the frequency range from 867.6 MHz to 868.0 MHz, two RF channels at a band width of 200 kHz are specified, which maximum level of effective radiated power (ERP) is restricted to 500 mW.

The aforementioned ETSI technical standards comprise also inter alia regulations about duty cycle and contention management. For instance the radio frequency identification (RFID) readers are restricted within a 10% duty cycle and without any frequency or channel hopping for 500 mW channels and “Listen-Before-Talk” (LBT) scheme for 2 W channels.

For the sake of completeness, it should be noted that a frequency range from 902 MHz to 928 MHz is allocated for UHF radio frequency identification (RFID) communication in the ITU Region 2 (North and South America and Pacific East of the International Date Line). The maximum level of effective isotropic radiated power (EIRP) level is restricted to 5 W with allowable frequency hopping (FH). Refer to FCC (Federal Communications Commission) 15.247 for details. With respect to the ITU Region 3 (Asia, Australia and the Pacific Rim West of the International Date Line), an allocation at 950 MHz is available.

With reference to FIG. 3, minimum permitted power levels for thresholds of the receiver of the radio frequency identification (RFID) reader while performing the aforementioned “Listen-Before-Talk” scheme are illustrated. The following table summarizes the levels, likewise:

| Effective radiated | |
|---|---|
| power in Transmission | Threshold level [ERP] |
| 0 mW to 100 mW | ≦−83 dBm |
| 101 mW to 500 mW | ≦−90 dBm |
| 501 mW to 2 W | ≦−96 dBm |

Any RF signal detected by a receiver of a radio frequency identification (RFID) reader in excess of one of the aforementioned threshold levels (i.e. in accordance with the transmission power) indicates that any other equipment (such as another RFID reader) already occupies the RF sub-band (band width 200 kHz), at which the RF signal has been detected. In such a situation, the radio frequency identification (RFID) reader should not transmit but monitor other RF sub-bands within the permitted RF band until it detects one in which the received RF signals are below the corresponding threshold level. Alternatively, the radio frequency identification (RFID) reader may remain on the same RF sub-band and postpone transmissions until it is defined that the sub-band is free (unoccupied).

In particular with respect to a transmission power above 500 mW, the sensitivity requirement (i.e. <−96 dBm) of the receiver of the radio frequency identification (RFID) reader is substantially high. This means that the implementation of a radio frequency identification (RFID) reader and especially the RF interface thereof is complicated, and cost intensive, in particular of the components required for realizing the RF interface circuitry. With reference to FIGS. 4 and 5, implementation details of a user terminal device according to embodiments of the present invention will be described.

FIG. 4 shows a schematic block illustration of components of a user terminal device in an exemplar form of a portable cellular communication enabled terminal 100. The terminal device 100 exemplarily represents any kind of processing terminal or device employable with the present invention. It should be understood that the present invention is neither limited to the illustrated terminal device 100 nor to any other specific kind of processing terminal or device. As aforementioned, the illustrated terminal device 100 is exemplarily embodied as a cellular communication enabled portable user terminal with radio frequency identification (RFID) communication capability. In particular, the terminal device 100 is embodied as a processor-based or micro-controller based system comprising a central processing unit (CPU) and a mobile processing unit (MPU) 10, respectively, a data and application storage 120, cellular communication means including cellular radio frequency interface (I/F) 180 with correspondingly adapted RF antenna (181) and subscriber identification module (SIM) 185, user interface input/output means including typically audio input/output (I/O) means 140 (conventionally a microphone and a loudspeaker), keys, keypad and/or keyboard with key input controller (Ctrl) 130 and a display with display controller (Ctrl) 150, and a (local) wireless and/or wired data interface (I/F) 160.

The operation of the terminal device 100 is controlled by the central processing unit (CPU)/mobile processing unit (MPU) 110 typically on the basis of an operating system or basic controlling application, which controls the functions, features and functionality of the terminal device 100 by offering their usage to the user thereof. The display and display controller (Ctrl) 150 are typically controlled by the processing unit (CPU/MPU) 110 and provide information for the user including especially a (graphical) user interface (UI) allowing the user to make use of the functions, features and functionality of the terminal device 100. The keypad and keypad controller (Ctrl) 130 are provided to enable the user inputting information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The keypad operable by the user for input comprises for instance alphanumeric keys and telephony specific keys such as known from ITU-T keypads, one or more soft keys having context specific input functionalities, a scroll-key (up/down and/or right/left and/or any combination thereof for moving a cursor in the display or browsing through the user interface (UI), a four-way button, an eight-way button, a joystick or/and a like controller.

The terminal device 100 according to a specific embodiment illustrated in FIG. 4 includes the cellular communication subsystem 180 coupled to the radio frequency antenna (181) and operable with the subscriber identification module (SIM) 185. The cellular communication subsystem 180 may be also designed as cellular (communication) interface (IF). The cellular communication subsystem 180 is arranged as a cellular transceiver to receive signals from the cellular antenna, decodes the signals, demodulates them, and also reduces them to the base band frequency. The cellular communication subsystem 180 provides for an over-the-air interface, which serves in conjunction with the subscriber identification module (SIM) 185 for cellular communications with a corresponding base station (BS) of a radio access network (RAN) of a public land mobile network (PLMN). The output of the cellular communication subsystem 180 thus consists of a stream of data that may require further processing by the processing unit (CPU/MPU) 110. The cellular communication subsystem 180 arranged as a cellular transceiver is also adapted to receive data from the processing unit (CPU/MPU) 110, which is to be transmitted via the over-the-air interface to the base station (BS) of the radio access network (RAN) (not shown). Therefore, the cellular communication subsystem 180 encodes, modulates and up-converts the data embodying signals to the radio frequency, which is to be used for over-the-air transmissions. The antenna (outlined) of the terminal device 100 then transmits the resulting radio frequency signals to the corresponding base station (BS) of the radio access network (RAN) of the public land mobile network (PLMN). The cellular communication subsystem 180 preferably supports a 2^{nd} Generation digital cellular network such as GSM (Global System for Mobile Communications) which may be enabled for GPRS (General Packet Radio Service) and/or EDGE (Enhanced Data for GSM Evolution; 2.5 Generation), a 3^{rd} generation digital cellular network such as any CDMA (Code Division Multiple Access) System including especially UMTS (Universal Mobile Telecommunications System) also designated as WCDMA (Wide-Band Code Division Multiple Access) System and cdma2000 System, and/or any similar, related, or future (3.9 Generation, 4^{th} Generation) standards for cellular telephony.

According to the different cellular standards various frequency bands are allocated for cellular communication. The following table lists a selection of frequency bands used; the table is not exhaustive. For later reference, commonly accepted abbreviations for the different frequency bands are denoted.

| | Uplink | Downlink |
|---|---|---|
| System Designation | RF Band [MHz] | RF Band [MHz] |
| GSM 900 (Europe): | 890-915 | 935-960 |
| GSM 1800 (Europe): | 1710-1785 | 1805-1880 |
| GSM 850 (USA): | 824-849 | 869-894 |
| GSM 1900 (USA): | 1850-1910 | 1930-1990 |
| cdma2000 (USA): | 1850-1910 | 1930-1990 |
| WCDMA 2100 (Europe): | 1920-1980 | 2110-2170 |

It should be understood that the cellular communication subsystem 180 may support cellular communication at multiple different frequency bands. For instance, the cellular communication subsystem 180 supports cellular communication at the frequency bands GSM 850, GSM 900, GSM 1800, and/or GSM 1900. Moreover, the cellular communication subsystem 180 may support cellular communication at multiple different protocols. For instance, the cellular communication subsystem 180 supports cellular communication according to the GSM standard and the UMTS standard or the GSM standard and the cdma2000 standard or any other combination thereof. The cellular communication subsystem 180 supporting cellular communication at multiple different frequency bands should be also designated as multi-band cellular communication subsystem 180, whereas the cellular communication subsystem 180 supporting cellular communication at multiple different protocols should be also designated as multi-mode cellular communication subsystem 180. Note that the cellular communication subsystem 180 may be a multi-band and multi-mode cellular communication subsystem 180.

The wireless and/or wired data interface (I/F) 160 is depicted exemplarily and should be understood as representing one or more data interfaces, which may be provided in addition to the above described cellular communication subsystem 180 implemented in the exemplary terminal device 100. A large number of wireless communication standards are available today. For instance, the terminal device 100 may include one or more wireless interfaces operating in accordance with any IEEE 802.xx standard, Wi-Fi standard, WiMAX standard, any Bluetooth standard (1.0, 1.1, 1.2, 2.0+EDR, LE), ZigBee (for wireless personal area networks (WPANs)), Infra-Red Data Access (IRDA), Wireless USB (Universal Serial Bus), and/or any other currently available standards and/or any future wireless data communication standards such as UWB (Ultra-Wideband).

The terminal device 100 comprising several communication interfaces including for instance a cellular communication interface 180, and one or more wireless communication interfaces 160 may be designed as multi-radio terminal device 100.

Moreover, the data interface (I/F) 160 should also be understood as representing one or more data interfaces including in particular wired data interfaces implemented in the exemplary terminal device 100. Such a wired interface may support wire-based networks such as Ethernet LAN (Local Area Network), PSTN (Public Switched Telephone Network), DSL (Digital Subscriber Line), and/or other available as well as future standards. The data interface (I/F) 160 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface, Flash card interface and the like.

The terminal device 100 according to an embodiment of the present invention comprises a radio frequency identification (RFID) reader subsystem 190 coupled to a RF antenna 194. Reference should be given to FIG. 1 and the aforementioned description thereof, which illustrates the basic implementation and operation of a radio frequency identification (RFID) reader module. The radio frequency identification (RFID) reader subsystem 190 may be included in the terminal 100, fixely connected to the terminal 100, or detachably coupled to the terminal 100. In particular, the radio frequency identification (RFID) reader subsystem 190 may be arranged on or in a cover of the terminal device 100, where the cover is preferably a detachable functional cover of the terminal device 100. In accordance with the inventive concept of the present invention, a communication controller (Ctrl) 200 is comprised by the terminal 100. The communication controller (Ctrl) 200 is connected to the terminal 100, the cellular interface 180, the radio frequency identification (RFID) reader subsystem 190, and preferably to any other communication interface of the terminal device 100. Details about the specific implementation of the radio frequency identification (RFID) reader subsystem 190 and the communication controller (Ctrl) 200 are presented in the following.

The components and modules illustrated in FIG. 4 may be integrated in the terminal device 100 as separate, individual modules, or in any combination thereof. Preferably, one or more components and modules of the terminal device 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constricted especially to size and power consumption constraints. Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

Typical applications operable with the terminal device 100 comprise beneath the basic applications enabling the data and/or voice communication functionality a contact managing application, a calendar application, a multimedia player application, a WEB/WAP browsing application, and/or a messaging application supporting for instance Short Message Services (SMS), Multimedia Message Services (MMS), and/or email services. Modern portable electronic terminals are programmable; i.e. such terminals implement programming interfaces and execution layers, which enable any user or programmer to create and install applications operable with the terminal device 100. A today's well established device-independent programming language is JAVA, which is available in a specific version adapted to the functionalities and requirements of mobile device designate as JAVA Micro Edition (ME). For enabling execution of application programs created on the basis of JAVA ME the terminal device 100 implements a JAVA MIDP (Mobile Information Device Profile), which defines an interface between a JAVA ME application program, also known as a JAVA MIDlet, and the terminal device 100. The JAVA MIDP (Mobile Information Device Profile) provides an execution environment with a virtual JAVA engine arranged to execute the JAVA MIDlets. However, it should be understood that the present invention is not limited to JAVA ME programming language and JAVA MIDlets; other programming languages especially proprietary programming languages are applicable with the present invention.

With reference to FIG. 5, the terminal device 100 implementing several different radio frequency communication interfaces is illustratively depicted. The multi-radio implementation shown in FIG. 5 is given for the way of illustration. The present invention should not be understood as limited to the specific embodiment illustrated in FIG. 5. The multi-radio implementation of the terminal device 100 comprises a cellular communication subsystem 180, a radio frequency identification (RFID) reader subsystem 190, a Bluetooth interface (I/F) 161, and a WLAN (wireless local area network) communication interface (I/F) 162.

The terminal device 100 comprises further the communication controller 200, which enables exercising control over the operation of the communication interfaces of the terminal device 100. In particular, the communication controller 200 enables operation of one or more communication interfaces in coordination with any other one or any other ones. For instance, communication controller 200 is provided to enable concurrent, substantially concurrent, and/or frequency- and/or time-aligned operation of the communication interfaces.

Referring to FIG. 5, the communication controller (μC) 200 is in charge of controlling functionalities and tasks of the cellular communication subsystem 180. An application controller (μC) 210 is provided to exercise control of the functionalities and tasks of the other communication interfaces including the radio frequency identification (RFID) reader subsystem 190, the Bluetooth interface 161, and the WLAN interface 162. In turn, the application controller (μC) 210 is connectivity to the communication controller (μC) 200, which comprises additionally a multi-radio controller (MRC) 205, which may be a logical entity in the communication controller (μC) 200 to schedule and control the different communication interfaces. The multi-radio controller (MRC) 205 is preferably responsible of handling multi-radio operations, providing time domain scheduling, providing frequency domain scheduling, and maintaining the radio system status information of each individual communication interface in the multi-radio terminal device 100. The multi-radio controller (MRC) 205 provides one or more higher-level multi-radio entities with the ability to control and execute measurements in different communication interfaces and to enable the required control for administrating the time domain scheduling functionality. Therefore, in a Listen-Before-Talk (LBT) scheme according to an embodiment of the invention, multi-radio controller (MRC) 205 may measure the UHF channels allocated by ETSI for the UHF radio frequency identification (RFID) communication through RF front-end interface of the cellular communication subsystem. The measurement results are then provided to the application (μC) 210, which further controls the operation of the radio frequency identification (RFID) reader subsystem in accordance with the measurement results.

The basic concept of the invention is to implement an advantageous LBT scheme. The initial check whether a RF sub-band is occupied (by any other RF equipment) or clear (unoccupied) may be initiated on a user input entered by a user of the terminal device 100. The user for instance indicates by the user input preferably through a user interface 30 of the terminal device 100 that on operation of the radio frequency identification (RFID) reader subsystem is requested. Alternatively, the initial check may be initiated upon receiving an initiation signal from an application 35 executable on the terminal device 100.

With reference to FIG. 6, an operational sequence applicable to a Listen-Before-Talk (LBT) scheme according to an embodiment of the present invention is schematically illustrates.

In operation S100, it is checked whether a sub-band scan for RF signals is requested. In case a check is instructed for instance upon signalization by user input via the user interface (30) of the terminal device 100 or by the application 35 executable on the terminal device 100, the operational sequence continues with operation S110. Otherwise, the listen loop procedures illustrated in FIG. 6 remains at operation S100.

The operation S100, where it is decided whether to initiate performing a Listen-Before-Talk measurement or not, may include further decisions required and/or usefully integrated into the operational sequence.

As aforementioned, the official regulations concerning frequency allocations, frequency sub-band allocations and/or sub-band definitions, sensitivity threshold definitions concerning measurement sensitivity requirements, and/or sensitivity threshold definitions depending on intended transmission power differ significantly over the world. Typically, manufacturers, which market their products world-wide have to take all these different official regulations into consideration when developing the products. More advantageously, the product development may implement multi-functionality to ensure conformity of their products with as many official regulations as possible.

In this sense, a geographic area may be determined, in which the terminal device 100 is currently located and operated. The geographic area typically includes a territory of a state, a territory of a community of states (where for instance the community is subjected to common regulations such as the European Union), and/or any other plurality of states (such as the definitions of the ITU Regions). Preferably, the geographic area is distinguished by official regulations to which all terminal devices are subjected, which are located therein. On the basis of the determined geographic area, it may be further checked whether Listen-Before-Talk measurement(s) is/are required for operating the radio frequency identification (RFID) reader subsystem. In case that Listen-Before-Talk measurement is not official required, the operational sequence returns for instance to S100 to enable re-check of the current location of the terminal device. Otherwise, the operational sequence continues. It should be noted that even Listen-Before-Talk measurement is not officially required Listen-Before-Talk measurement(s) may be performed nevertheless to identify unoccupied and/or occupied sub-bands.

Moreover, on the basis of the determined geographic area the official regulations are known; e.g. a plurality of different official regulations may be provided for being selected in dependence on the determined geographic area. The Listen-Before-Talk measurement may be then performed in accordance with the official regulations, which in particular comprise one or more frequency allocations, one or more radio frequency sub-band definitions, and/or one or more sensitivity threshold definitions.

In particular, the one or more radio frequency sub-bands to be inspected by Listen-Before-Talk measurements are selected on the basis of the official regulations.

More specifically, information relating to a location of the radio frequency identification (RFID) reader subsystem 190 and the terminal device 100 is obtained, respectively. The location related information may include information relating to an operator and/or a cell. The information relating to an operator and/or a cell may be obtained from the wireless communication subsystem. In particular, the information about the operator may include an operator identifier, which identifies the operator of the wireless communication network into which the wireless communication subsystem is currently subscribed; e.g. the operation identifier may be an operator identifier identifying the operator of a Public Land Mobile Network (PLMN) or cellular network or an operator identifier identifying the operator of a (public/private) Wireless Local Area Network (WLAN), a Wi-Fi network, a WiMAX network, or the like. The information about the operator may include a region identifier, which identifies for instance a region, a geographic area, a city area, or a territory, where the operator offers its communication services.

The information about the cell may include a cell identifier, which identifies a cell, within which coverage area the wireless communication network is currently operated. The cell may be a cell of a Public Land Mobile Network (PLMN) or cellular network as well as a cell of a (public/private) Wireless Local Area Network, a WiFi Network, a WiMAX network, or the like.

The information about the cell may include position information or a region identifier. The position information may indicate the geographic position of the center of the cell, the antenna tower of the cell, and/or the position of the base station (BS, nodeB) of the cell. The region identifier may identify for instance a region, a geographic area, a city area, or a territory, where the operator offers its communication services

On the basis of the location related information and a look-up table, the current location of the radio frequency identification (RFID) reader subsystem 190 and the terminal device 100 can be obtained, respectively. It should be noted that a coarse location resolution may be acceptable to enable selection of the official regulation, to which attention has to be paid.

Moreover, the current location may be likewise determined on the basis of position information obtained from a positioning system or positioning/location service. Such position information may be obtained from a satellite based positioning system such as GPS (Global Positioning System) or the coming Galileo system. Position information may be also obtained through wireless communication systems, for instance on the basis of signal delay measurements, triangulations, and the like. In particular, cellular communication systems support such positioning/location services.

In addition, a transmission power level intended to be used by the radio frequency identification (RFID) reader subsystem for radio frequency identification (RFID) communication may be obtained or estimated. Moreover, the (maximum) transmission power level intended for use may be defined. Official regulations may have to be considered, as aforementioned. In particular, a maximum transmission power level intended for use may be officially regulated. In dependence on the transmission power level intended for use it may be considered whether the Listen-Before-Talk measurement is required (in accordance with the official regulations). A power level threshold may be provided and the Listen-Before-Talk measurement is intended to be performed in case the transmission power level intended for use exceeds a power level threshold. The power level threshold in dependence on the transmission power level intended for use, capabilities of the radio frequency identification (RFID) reader subsystem, one or more presettings obtainable from the radio frequency identification (RFID) reader subsystem, and/or official regulations. The power level threshold may depend on Listen-Before-Talk capabilities and/or a maximum transmission power level operable with the radio frequency identification (RFID) reader subsystem. The presettings obtainable from the radio frequency identification (RFID) reader subsystem may comprise properties of the radio frequency identification (RFID) reader subsystem. A power level threshold depending on capabilities and/or presettings of the radio frequency identification (RFID) reader subsystem may ensure to operate the Listen-Before-Talk measurement(s) at specifications set by the radio frequency identification (RFID) reader subsystem.

In operation S110, it is check whether the cellular communication subsystem 180 is currently active. Due to the time requirement of an Listen-Before-Talk (LBT) process (at least 5 ms), RF signal measurement may be preferably performed when the cellular communication subsystem 180 in idle operation state or standby operation state. For instance during active operation state, there may be periods of non-activity within a time frame of a TDMA system such as GSM. These periods or non-activity may comprise one or more time slots (each having a time length of approximately 0.577 ms) of each time frame. For instance, in case one time slot is assigned to uplink communication and another time slot is assigned to downlink communication, a maximum period of non-activity of (8−2)×0.577 ms≈3.5 ms might be available. Additionally, it should be noted that the unassigned time slots are not necessarily successive in time and the inter-cell and/or intra-cell measurement operations may be assigned to one or more further time slots.

It should be noted that the terms idle operation state, standby operation state, and active operation state address to a current operation state relating to the operativeness of the cellular communication subsystem 180. In particular, idle/standby operation state designates an operation state of the cellular communication subsystem 180, where the operation of the cellular communication subsystem is limited to paging and measurement operations. In active operation state, data and/or voice communications are performed through the cellular communication subsystem 180 with the Radio Access Network (RAN) of the Public Land Mobile Network (PLMN), to which the cellular communication subsystem is subscribed.

The operational sequence described in the following with reference to FIG. 6 may be implemented by the means of the communication controller 200 comprising the multi-radio controller 205 and the application controller 210. Further, the operational sequence representing a listening loop algorithm to enable “Listen-Before-Talk” measurement and, if desired, subsequent radio frequency identification (RFID) communications may be implemented on the basis of software sections and/or hardware components. Moreover, one or more software sections may be operable with the processing unit (110) of the terminal device 100.

According to operation S110, the operational sequence continues with operation S120 in case the cellular communication subsystem 180 is currently in idle/standby operation state; otherwise the operational sequence returns to operation S110 for awaiting idle/standby operation state of the cellular communication subsystem 180.

In operation S120, system information is obtained from the cellular communication subsystem 180. Inter alia, the system information comprises primarily paging related information and measurement related information.

In idle operation state, beneath the standby operations there is not present any terminal originated data and/or voice communication to be transmitted to the Radio Access Network (RAN) of the Public Land Mobile Network (PLMN), to which the cellular communication subsystem 180 is currently subscribed. The standby operations comprises processes, which ensure that the cellular communication subsystem 180 is able to receive terminal terminated data and/or voice communications transmitted by the Radio Access Network (RAN) to the cellular communication subsystem 180 of the terminal device 100. As aforementioned, the cellular communication subsystem 180 is typically configured for being able to receive paging messages from the Radio Access Network (RAN), which are transmitted to the cellular communication subsystem 180 to indicate that a communication link for data and/or voice communication is requested. Moreover, the cellular communication subsystem 180 is typically configured to perform RF signal quality measurements relating to intra-cell power levels, adjacent cell (inter-cell) power levels, and/or availability of other systems. On the basis of these measurements, the Radio Access Network (RAN), receiving a measurement protocol from the cellular communication subsystem 180 may ensure that the cellular communication subsystem 180 is within the coverage area of a PLMN cell such that the cellular communication subsystem 180 and the Radio Access Network (RAN) is always able to initiate communication, respectively. Moreover, the cellular communication subsystem 180 of the terminal device 100 may be allowed to transmit random access messages at any time, when required.

The operations of the cellular communication subsystem 180 will be exemplarily discussed in more detail in the following with reference to the GSM standard.

The control and management of a Public Land Mobile Network (PLMN) requires a relative signalizing. The GSM standard defines several Control Channels (CCHs) to provide cellular terminals including cellular communication subsystems continuous, packet-based signaling services through the air interface, to receive messages from and transmit messages to the RAN at any time. A Common Control Channel (CCCH), which is part of the aforementioned Control Channels (CCH), comprises a Paging Channel (PCH), which is part of the downlink of the Common Control Channel (CCCH). The Paging Channel (PCH) is required for paging messages to localize cellular terminals such as terminal device 100. Each cellular terminal, once registered to a Radio Access Network (RAN), is allocated to a paging group (CCCH_GROUP), which can comprise several cellular terminals. The paging group (CCCH_GROUP) is assigned to one specific Common Control Channel (CCCH) of the plurality of Common Control Channels (CCCHs). Upon transmission of a paging message on the Common Control Channel (CCCH) assigned to a specific paging group (CCCH_GROUP), the cellular terminals belonging to this paging group (CCCH_GROUP) decode the paging message, which comprises inter alia a cellular terminal identifier. The identified cellular terminal, to which the paging message is addressed, requests on the Random Access Channel (RACH) a Control Channel (CCH).

With reference to FIG. 7, a typical frame structure in accordance with the GSM standard is exemplarily illustrated. The mapping of logical channels onto a physical channel comprises two components: the mapping in the frequency domain and the time domain. This means, the mapping of the logical channels onto a physical channel is based on a TDMA frame structure and frequencies allocated to a cellular terminal (Mobile Allocation; MA) and a base station (Cell Allocation; CA) of the RAN, to which base station the cellular terminal is currently connected.

In the time domain, the logical channels are organized in a complex frame structure placed above the TDMA methodology. The frame structure comprises so-called hyperframes, superframes, and multiframes. In view of the organization of the Control Channels, the multiframe structure is of special interest. The multiframe structure defines the mapping of logical sub-channels onto physical channels. These exists a first type of multiframes including 26 frames designated 26-frame multiframe (not shown in FIG. 7) and a second type including 51 frames designated 26-frame multiframe. The 26-frame multiframe is organized in a superframe including 51 26-frame multiframes (not shown in FIG. 7), whereas the 51-frame multiframe is organized in a superframe including 26 51-frame multiframes. Each hyperframe comprises 2048 superframes.

The second type of multiframes, i.e. the 51-frame multiframe, is relevant in view of the operation of the cellular communication subsystem in idle operation state, especially the paging scheme.

Referring back to the aforementioned paging scheme, a parameter BS_CC_CHANS in the BCCH (Broadcast Control Channel) defines the number of basic physical channels supporting Common Control Channels (CCCHs). All common control channels (CCCHs) use time slots on a specific radio frequency channel of the Cell Allocation (CA). Each Common Control Channel (CCCH) carries its own CCCH_GROUP identifier of cellular communication subsystems (or cellular terminals) in idle operation state. The cellular communication subsystems belonging to a specific CCCH_GROUP listen for paging messages and, if necessary, make random accesses only on the specific Common Control Channel (CCCH) to which the CCCH_GROUP belongs. The method by which a mobile determines the CCCH_GROUP to which it belongs is defined in the following:

CCCH_GROUP(0 . . . BS_CC_CHANS−1)=((IMSI mod 1000)mod(BS_CC_CHANS*N))div N; and

where
N is a number of paging blocks “available” on one Common Control Channel (CCCH);
(i.e. N is the number of paging blocks “available” in a 51-multiframe on one Common Control Channel (CCCH) times BS_PA_MFRMS);
IMSI is the International Mobile Subscriber Identity;
“mod” defines the Modulo calculation operation; and
“div” defines the Integer division calculation operation.

The parameter BS_PA MFRMS on the BCCH (Broadcast Control Channel), indicates the number of 51-multiframes between transmissions of paging messages to cellular terminals (or cellular communication subsystems) in idle operation state of the same paging group. The “available” paging blocks per CCCH are then those “available” per 51-multiframe on that CCCH (determined by the two above parameters) multiplied by BS_PA_MFRMS. Mobiles are normally only required to monitor every N-th block of their paging channel, where N equals the number of “available” blocks in total (determined by the above BCCH parameters) on the Paging Channel (PCH) of the specific CCCH, which their CCCH_GROUP is required to monitor. The parameter BS_PA_MFRMS is also designated as Paging Repeat Period (PRP).

This means that the parameter BS_PA MFRMS indicates the number of 51-multiframes between transmission of paging messages to cellular terminal of the same paging group. The parameter BS_PA_MFRMS comprises 3 bits and may have a value in the range from 2 to 9.

It should be noted that other paging modes (e.g. page reorganize or paging overload conditions) may require the cellular terminal to monitor paging blocks more frequently than in normal paging mode described in detail above. All the cellular terminals, which listen to a particular paging block, are defined as being in the same PAGING_GROUP. The method by which a particular mobile determines to which particular PAGING_GROUP it belongs and hence which particular block of the available blocks on the paging channel is to be monitored is defined as following:

PAGING_GROUP(0 . . . N−1)=((IMSI mod 1000)mod(BS_CC_CHANS*N))mod N.

It should be also noted that the RAN (Radio Access Network) is allowed to send transmissions on the paging sub-channel for a given cellular terminal every BS_PA_MFRMS 51-multiframes or, in case discontinuous Reception (DRX) period split is supported, every 1/N_{DRX} 51-multiframes, where N_{DRX} is the average number of monitored blocks per 51 multiframe in discontinuous Reception (DRX) mode according to its paging group The cellular terminal or cellular communication subsystem of terminal is required to attempt to decode a transmission every time its paging sub-channel is sent.

Overall, the duration a GSM based cellular communication subsystem is non-active during idle/standby operation state varies within the range from approximately 460 ms to 2.1 s, when BS_PA_MFRMS parameter or Paging Repeat Period (PRP) is not considered. As aforementioned, the BS_PA_MFRMS parameter or Paging Repeat Period (PRP) is allowed to have a value in the range of 2 to 9. One BS_PA_MFRMS unit or Paging Repeat Period (PRP) unit corresponds to a duration of a 51-multiframe (i.e. 51 frames), which is approximately 4.615 ms.

The BS_PA_MFRMS parameter or Paging Repeat Period (PRP) is set by the Radio Access Network (RAN) and the Base Station (BTS) thereof, respectively. Typically, a value of the BS_PA_MFRMS parameter or Paging Repeat Period (PRP) between 6 to 9 is defined depending on the Radio Access Network (RAN) and network requirements. Consequently, in case of typical BS_PA_MFRMS parameter or Paging Repeat Period (PRP) values (from 6 to 9) and a 51-multiframe duration of approx. 4.615 ms, a period of non-activity in the range from 27.69 ms to 41.535 ms is principally available.

It should be noted that measurement operations of the cellular communication subsystem are not considered. Such intra- and inter-cell measurements may be suspended. When considering that it has to be assumed that the cellular communication subsystem does not change its location, at least inter-cell measurements can be omitted without restrictions in the availability of the cellular communication subsystem by the RAN.

As aforementioned, a RF signal measurement in accordance with the LBT (“Listen-Before-Talk”) scheme requires a period of time within the time range from minimal 5 ms to maximal 10 ms. When repeatedly performing a RF signal measurement in accordance with the LBT (“Listen-Before-Talk”) scheme, the required period of time may last up to several tens of milliseconds. Moreover, a reading out of a radio frequency identification (RFID) transponder (i.e. in a single scan operation) may require typically about 10 ms, when the Listen-Before-Talk (LBT) operation is omitted in time calculation.

The obtaining of the system information from the cellular communication subsystem 180 may be performed on the basis of a communication between communication controller 200 and cellular communication subsystem 180. The aforementioned communication may include one or more control commands and responses.

In operation S130, the available period of non-activity is determined from the timing information obtained by the cellular communication subsystem from the Radio Access Network (RAN). Above, the timing requirements of the cellular communication subsystem are described in detail. In accordance with these timing requirements (especially the timing requirements relating to paging of the cellular communication subsystem) the periods of non-activity are obtainable and determinable.

In operation S140, it is checked whether a period of non-activity determined in operation S130 from the system information is sufficient for performing a LBT (“Listen-Before-Talk”) operation. Moreover, it may be also considered during check whether a period of non-activity determined in operation S130 from the system information is sufficient for performing a LBT (“Listen-Before-Talk”) operation and a subsequent radio frequency identification (RFID) communication operation.

Performing of a radio frequency identification (RFID) communication operation during a period of non-activity of the cellular communication subsystem is advantageous, because of interference which may be caused in the frequency bands used during data and/or voice communication in active operation state of the cellular communication subsystem. Due to the high power level used in radio frequency identification (RFID) communication (up to maximal 2 W), such interference may cause degradation of the RF signal quality in cellular communication, which results at least in an increased error probability of the cellular communication and, in a worst case scenario, to a loss of the communication link between RAN and cellular communication subsystem.

In case the check in operation S140 is successful, the operational sequence continues with operation S150. Otherwise, the operational sequence returns to operation S110 or operation S120 in order to obtain system information and determine periods of non-activity once again.

In operation S150, the communication controller 200 of the terminal device 100 is configured to initiate performing the Listen-Before-Talk (LBT) measurement operation. According to an embodiment of the present invention, the communication controller 200 comprising the multi-radio controller (MRC) 205 and the application controller 210, is adapted to configure the cellular subsystem 180 for Listen-Before-Talk (LBT) measurement operation. In order to enable Listen-Before-Talk (LBT) measurement operation, the communication controller 200 is synchronized to the period of non-activity of the cellular communication subsystem 180. In accordance with the period of non-activity, which is selected to be adequate for performing the Listen-Before-Talk (LBT) measurement operation and, if desired, a subsequent radio frequency identification (RFID) communication with one or more radio frequency identification (RFID) transponders within the coverage area of the radio frequency identification (RFID) reader subsystem, the communication controller 200 exercising control over the cellular communication subsystem configures the cellular communication subsystem to perform a RF signal measurement at least one of sub-bands intended for use in radio frequency identification (RFID) communication. In addition the cellular communication subsystem is adjusted to a sub-band width of 200 kHz and a sensitivity level of the cellular communication subsystem is adapted to sensitivity level requirements applied for Listen-Before-Talk (LBT) measurements. The sensitivity requirements depend of the radio frequency identification (RFID) sub-band(s) and the power level(s) intended to be used in radio frequency identification (RFID) communication. The configuring of the cellular communication subsystem 180 by the means of the communication controller 200 may be performed on the basis of a communication between communication controller and cellular communication subsystem. The aforementioned communication may include one or more control commands and responses.

For example, the cellular communication subsystem may be a multi-band cellular communication subsystem 180 supporting GSM 850, GSM 900 and GSM 1800. In correspondence with the UHF band allocated for radio frequency identification (RFID) communication, the GSM 850 transceiver section of the cellular communication subsystem 180 may be configured for Listen-Before-Talk (LBT) measurement. The operation radio frequency band of the GSM 850 transceiver section is substantially close to the radio frequency band of UHF radio frequency identification (RFID) communication.

It should be noted that the Listen-Before-Talk (LBT) measurement operation may be performed on one sub-band applicable for radio frequency identification (RFID) communication or the Listen-Before-Talk (LBT) measurement operation may be performed on one or more sub-bands applicable for radio frequency identification (RFID) communication. In the latter case, the Listen-Before-Talk (LBT) measurement operation on several sub-bands applicable for radio frequency identification (RFID) communication may be advantageous to enable detection which sub-bands are occupied and which are clear out of a plurality of sub-bands.

In operation S160, the cellular communication subsystem 180 is activated in synchronicity with the determined period of non-activity selected for Listen-Before-Talk (LBT) measurement operation, preferably under control of the communication controller 200.

In operation S170, the cellular communication subsystem 180, which is configured to perform the Listen-Before-Talk (LBT) measurement operation by the communication controller 200, measures the one or more RF signal levels on the one or more commanded radio frequency identification (RFID) sub-bands at the corresponding band width (i.e. 200 kHz) and the corresponding sensitivity level(s). The Listen-Before-Talk (LBT) measurement operation is performed for at least 5 ms or 5 ms+r (where r is a random value between 0 ms and 5 ms) according to the requirements of the Listen-Before-Talk (LBT) scheme explained above.

It should be noted that a RF receiver font-end of a typical GSM cellular communication subsystem such as subsystem 180 has a sensitivity threshold as low as −114 dBm (ERP) and a channel precision of 200 kHz. As a result, the cellular communication subsystem 180 is applicable for Listen-Before-Talk (LBT) measurement operation because the sensitivity threshold is better than the required threshold with respect to the frequency allocation regulations in radio frequency identification (RFID) communication.

Moreover, the RF receiver font-end of the cellular communication subsystem 180 exceeds the sensitivity requirements imposed by the frequency allocation regulations concerning Listen-Before-Talk (LBT) measurement. In order to reduce the power consumption of the cellular communication subsystem 180 during Listen-Before-Talk (LBT) measurement operation, the front-end noise figure of the cellular communication subsystem 180 may be relaxed by a pre-defined value (dependent on the sensitivity threshold permitted fro LBT measurement). For instance the front-end noise figure of the cellular communication subsystem 180 may be relaxed by 15 dB.

For link control, the cellular communication subsystem 180 includes typically a radio subsystem link control entity of functionality, which is primarily used to measure the RF signal quality on downlink channels for cell section, handover preparation, and power control. This kind of RF signal measurement is conventionally known as quality monitoring.

Especially during idle/standby operation state of the cellular communication subsystem 180 the carrier of the BCCH (Broadcast Control Channel) is monitored. The base station (BTS) of each cell emits the BCCH carrier. The cellular communication subsystem monitors the BCCH carrier of the current cell (to which it is currently assigned) and of neighboring cells. On the basis of the quality monitoring of the BCCH carrier, the cellular communication subsystem 180 can ensure to select that cell at each time, with which the cellular communication subsystem 180 can reliably communication at the highest probability. The quality of a channel is typically described on the basis of two parameters, the received signal strength (RELEV) in dB and the received signal quality (RXQUAL) measured on the basis of a bit error rate.

Those skilled in the art will appreciate that the received signal strength (RELEV) measurement can be adopted to enable Listen-Before-Talk (LBT) measurement. During Listen-Before-Talk (LBT) measurement, it is measured whether a interrogation RF signal (excitation RF signal, continuous wave) is present. The interrogation RF signal is radiated by a radio frequency identification (RFID) reader for activating and/or energizing one or more radio frequency identification (RFID) transponder within its coverage area. In case the received signal strength (RELEV) measurement results in detecting the presents of a RF signal having a signal strength exceeding the regulation specific threshold, the sub-band at which the RF signal has been detected is assumed to be occupied. Vie versa, in case the received signal strength (RELEV) measurement results detecting the presents of a RF signal having a signal strength below the regulation specific threshold, the sub-band at which the RF signal has been detected is assumed to be clear or unoccupied.

In operation S180, according to the measurement results obtained from the cellular communication subsystem 180, it is checked whether one or more of the measured sub-bands applicable for radio frequency identification (RFID) communication are clear or unoccupied. In case all measured sub-bands are occupied, the measurement operation should be repeated and the operation sequence returns to operation S190, operation S140, or operation S110.

In operation S190, it is checked whether the Listen-Before-Talk (LBT) measurement should be performed at one or more other sub-bands applicable for radio frequency identification (RFID) communication. Correspondingly, one or more other sub-bands may be selected for Listen-Before-Talk (LBT) measurement, in operation S200, and the operational sequence continues with operation S140 or operation S110.

In operation S210, the radio frequency identification (RFID) reader subsystem 190 is configured in accordance with the Listen-Before-Talk (LBT) measurement result(s). This means, the communication controller 200 configures preferably by the means of the application controller 210 to operate at a sub-band applicable for radio frequency identification (RFID) communication, which has been identified during Listen-Before-Talk (LBT) measurement to be clear (unoccupied). In addition, the communication controller 200 may trigger the radio frequency identification (RFID) reader subsystem 190 to operate subsequent radio frequency identification (RFID) communication. The subsequent radio frequency identification (RFID) communication is preferably performed in time-aligned coordinated with the one or more periods of non-activity of the cellular communication subsystem 180. The time-aligned operation of the radio frequency identification (RFID) reader subsystem 190 is advantageous to prevent any interference between the RF signal communication occurring in consequence to the operation of the cellular communication subsystem 180 and the operation of the radio frequency identification (RFID) reader subsystem 190. During subsequent radio frequency identification (RFID) communication the radio frequency identification (RFID) reader subsystem 190 emits at least the RF interrogation signal (excitation signal, continuous wave) to energize and/or activate the one or more radio frequency identification (RFID) transponders located within the coverage area of the radio frequency identification (RFID) reader subsystem 190.

In summary, those skilled in the art will appreciate from the description above illustrated on the basis of non-limiting embodiments that the basic concept of the present invention is to provide a Listen-Before-Talk (LBT) scheme, which performs the signal strength measurement required for radio frequency identification (RFID) communication due to administrational regulations by the means of the RF interface front-end of a cellular communication subsystem, which typically implements a receiver component of high sensitivity. The usage of the cellular communication subsystem for Listen-Before-Talk (LBT) measurements removes the requirement of implementing a RF interface front-end of a radio frequency identification (RFID) reader subsystem fulfilling the comparable demanding sensitivity requirements established by the administrational regulations with regard of the frequency allocation for UHF radio frequency identification (RFID) communication. Such demanding sensitivity requirements are not required for UHF radio frequency identification (RFID) communication with between radio frequency identification (RFID) reader subsystem and radio frequency identification (RFID) transponder. Hence, the inventive concept allows providing an economic implementation of radio frequency identification (RFID) reader subsystems in terminal device capable for cellular communication.

The presence of a central communication controller, which exercise control over both the cellular communication subsystem and the radio frequency identification (RFID) reader subsystem, is advantageous for enabling configuration of both subsystems required for performing the aforementioned Listen-Before-Talk (LBT) measurement methodology. In particular, the central communication controller enables to operate both subsystem in a coordinated way to eliminate or at least minimize the probability of interference between RF signal communications occurring in response to the operation of the cellular communication subsystem and the radio frequency identification (RFID) reader subsystem, respectively.

It should be noted that the basic concept, although embodied in the view of UHF radio frequency identification (RFID) communication technology, is not limited thereto. In view of future development radio frequency identification (RFID) communication in the 2.4 GHz ISM frequency band will gain importance. Those skilled in the art will appreciate on the basis of the above description with respect to embodiments of the invention, that likewise a WLAN and/or Bluetooth communication subsystem with a high sensitive transceiver (especially RF interface front-end receiver) is applicable for Listen-Before-Talk (LBT) measurement in the sense of the core concept of the present invention.

It will be obvious for those skilled in the art that as the technology advances, the inventive concept can be implemented in a broad number of ways. The invention and its embodiments are thus not limited to the examples described above but may vary within the scope of the claims.

1. Method of performing a Listen-Before-Talk measurement to enable identifying of one or more unoccupied radio frequency sub-bands applicable for radio frequency identification (RFID) communication operable with a radio frequency identification (RFID) reader subsystem; said method comprising: obtaining timing information relating to one or more periods of activity of a wireless communication subsystem; deriving information about one or more periods of non-activity from said timing information; configuring said wireless communication subsystem to perform said Listen-Before-Talk measurement in coordination with said one or more periods of non-activity; and performing said Listen-Before-Talk measurement by the means of the wireless communication subsystem to identify said one or more unoccupied radio frequency sub-bands.

2. Method according to claim 1, comprising: measuring one or more radio frequency signal power levels on said one or more radio frequency sub-bands; and -determining whether said one or more radio frequency sub-bands are occupied or not in accordance with one or more sensitivity thresholds.

3. Method according to claim 1, wherein said sensitivity thresholds are defined in dependence on said radio frequency sub-bands.

4. Method according to claim 1, comprising: configuring said radio frequency identification (RFID) reader subsystem in accordance with a result of said Listen-Before-Talk measurement to enable radio frequency identification (RFID) communication on one of said unoccupied radio frequency sub-bands.

5. Method according to claim 1, comprising: configuring said one or more sensitivity thresholds of said wireless communication subsystem with respect to requirements of sensitivity thresholds in accordance with radio frequency identification (RFID) communication regulations.

6. Method according to claim 1, wherein said timing information relating to one or more periods of activity comprises timing information relating to time periods, at which said wireless communication subsystem emits one or more radio frequency signals, and/or time intervals, at which said wireless communication subsystem is enabled receiving one or more radio frequency signals.

7. Method according to claim 1, wherein said timing information relating to one or more periods of activity comprises timing information relating to paging periods, at which receiving of one or more paging messages is enabled.

8. Method according to claim 1, comprising: determining operation state of the wireless communication subsystem, wherein said operation state comprises at least an idle operation state and an active operation state; and enabling said Listen-Before-Talk measurement in case of idle operation state.

9. Method according to claim 1, comprising: determining whether said radio frequency identification (RFID) reader subsystem is currently located within a geographic area which subjected to official regulations requiring Listen-Before-Talk measurement; and performing said Listen-Before-Talk measurement in accordance with said official regulations, wherein said official regulations includes at least one out of a group comprising one or more radio frequency sub-band definitions and one or more sensitivity thresholds.

10. Method according to claim 9, comprising: selecting one or more radio frequency sub-bands in accordance with said official regulations.

11. Method according to claim 9, comprising: obtaining information relating to a location of said radio frequency identification (RFID) reader subsystem, wherein said location related information includes information about an operator and/or a cell, in particular an operator and/or a cell identifier; and determining said location on the basis of said location related information and/or a look-up table.

12. Method according to claim 9, comprising:
determining said location on the basis of position information obtained from a positioning system.

13. Method according to claim 1, comprising: obtaining a transmission power level intended to be used by said radio frequency identification (RPID) reader subsystem for radio frequency identification (RFID) communication; and performing said Listen-Before-Talk measurement in case said transmission power level intended for use exceeds a power level threshold.

14. Method according to claim 13, comprising: defining said power level threshold in dependence on at least one out of a group comprising said transmission power level intended for use, capabilities of said radio frequency identification (RPID) reader subsystem, presettings of said radio frequency identification (RPID) reader subsystem, and/or official regulations.

15. Method according to claim 1, wherein said wireless communication subsystem is at least one of a cellular communication subsystem and a wireless network communication subsystem.

16. Method according to claim 15, wherein said wireless communication subsystem is at least one of a GSM based cellular communication subsystem, a Bluetooth subsystem, or an IEEE 802.xx based subsystem.

17. Method according to claim 15, wherein said cellular communication subsystem is enabled for GSM 850 conform operation.

18. Method according to claim 1, wherein said radio frequency sub-bands are located in an ultra-high frequency band, in particular within a frequency range from 860 MHz to 960 MHz.

19. Method according to claim 1, wherein said ultra-high frequency band is defined in accordance with frequency allocation of the ETSI for ultra-high frequency radio frequency identification (RPID) communication.

20. Computer program product comprising program code sections stored on a machine-readable medium for carrying out the operations of claim 1, when said program product is run on a processor-based device, a terminal device, a network device, a portable terminal, a consumer electronic device, or a wireless communication enabled terminal.

21. Controlling module for enabling Listen-Before-Talk measurement to allow identifying of one or more unoccupied radio frequency sub-bands applicable for radio frequency identification (RFID) communication operable with a radio frequency identification (RFID) reader subsystem; wherein said controlling module is operable to exercise control over a wireless communication subsystem and said radio frequency identification (RFID) reader subsystem; wherein said controlling module is arranged for obtaining timing information relating to one or more periods of activity of said wireless communication subsystem therefrom; wherein said controlling module is configured to derive information about one or more periods of non-activity from said timing information; wherein said controlling module is arranged for configuring said wireless communication subsystem to perform said Listen-Before-Talk measurement in coordination with said one or more periods of non-activity; and wherein said controlling module is arranged for instructing said wireless communication subsystem to perform said Listen-Before-Talk measurement to identify said one or more unoccupied radio frequency sub-bands.

22. Controlling module according to claim 21, wherein said controlling module is arranged for obtaining one or more radio frequency signal power levels on said one or more radio frequency sub-bands in response to said measuring; and wherein said controlling module is configured to determine whether said one or more radio frequency sub-bands are occupied or not in accordance with one or more sensitivity thresholds.

23. Controlling module according to claim 21, wherein said sensitivity thresholds are defined in dependence on said radio frequency sub-bands.

24. Controlling module according to claim 21, wherein said controlling module is arranged for configuring said radio frequency identification (RFID) reader subsystem in accordance with a result of said Listen-Before-Talk measurement to enable radio frequency identification (RFID) communication on one of said unoccupied radio frequency sub-bands.

25. Controlling module according to claim 21, wherein said controlling module is arranged for configuring said one or more sensitivity thresholds of said wireless communication subsystem with respect to requirements of sensitivity thresholds in accordance with radio frequency identification (RFID) communication regulations.

26. Controlling module according to claim 21, wherein said timing information relating to one or more periods of activity comprises timing information relating to time periods, at which said wireless communication subsystem emits one or more radio frequency signals, and/or time intervals, at which said wireless communication subsystem is enabled receiving one or more radio frequency signals.

27. Controlling module according to claim 21, wherein said timing information relating to one or more periods of activity comprises timing information relating to paging periods, at which receiving of one or more paging messages is enabled.

28. Controlling module according to claim 21, wherein said controlling module is arranged for determining operation state of the wireless communication subsystem, wherein said operation state comprises at least an idle operation state and an active operation state; and wherein said controlling module is arranged for enabling said Listen-Before-Talk measurement in case of idle operation state.

29. Controlling module according to claim 21, wherein said controlling module is arranged for determining whether said radio frequency identification (RFID) reader subsystem is currently located within a geographic area which subjected to official regulations requiring Listen-Before-Talk measurement, wherein said controlling module is further arranged for enabling said Listen-Before-Talk measurement in accordance with said official regulations, wherein said official regulations includes at least one out of a group comprising one or more radio frequency sub-band definitions and one or more sensitivity thresholds.

30. Controlling module according to claim 29, wherein said controlling module is arranged for selecting one or more radio frequency sub-bands in accordance with said official regulations.

31. Controlling module according to claim 29, wherein said controlling module is configured to obtain information relating to a location of said radio frequency identification (RFID) reader subsystem, wherein said location related information includes information about an operator and/or a cell, in particular an operator and/or a cell identifier, wherein said controlling module is arranged for determining said location on the basis of said location related information and a look-up table.

32. Controlling module according to claim 29, wherein said controlling module is arranged for determining said location on the basis of position information obtained from a positioning system.

33. Controlling module according to claim 21, wherein said controlling module is configured to obtain a transmission power level intended to be used by said radio frequency identification (RFID) reader subsystem for radio frequency identification (RFID) communication, wherein said controlling module is arranged for enabling said Listen-Before-Talk measurement in case said transmission power level intended for use exceeds a power level threshold.

34. Controlling module according to claim 33, wherein said controlling module is configured to define said power level threshold in dependence on at least one out of the group comprising said transmission power level intended for use, capabilities of said radio frequency identification (RFID) reader subsystem, presettings of said radio frequency identification (RFID) reader subsystem, and/or official regulations.

35. Controlling module according to claim 21, wherein said wireless communication subsystem is at least one of a cellular communication subsystem and a wireless network communication subsystem.

36. Controlling module according to claim 35, wherein said wireless communication subsystem is at least one of a GSM based cellular communication subsystem, a Bluetooth subsystem, or an IEEE 802.xx based subsystem.

37. Controlling module according to claim 29, wherein said cellular communication subsystem is enabled for GSM (Global System for Mobile Communication) conform operation and in particular GSM 850 conform operation.

38. Controlling module according to claim 21, wherein said radio frequency sub-bands are located in an ultra-high frequency band, in particular within a frequency range from 860 MHz to 960 MHz.

39. Controlling module according to claim 21, wherein said ultra-high frequency band is defined in accordance with frequency allocation of the ETSI (European Telecommunications Standards Institute) for radio frequency identification (RFID) communication at ultra-high frequency band.

40. Terminal device enabled for Listen-Before-Talk measurement to allow identifying of one or more unoccupied radio frequency sub-bands applicable for radio frequency identification (RFID) communication operable with a radio frequency identification (RFID) reader subsystem, said terminal device comprising at least a wireless communication subsystem and said radio frequency identification (RFID) reader subsystem, wherein a controlling module of said terminal device is operable to exercise control over a wireless communication subsystem and said radio frequency identification (RFID) reader subsystem; wherein said controlling module is arranged for obtaining timing information relating to one or more periods of activity of said wireless communication subsystem therefrom; wherein said controlling module is configured to derive information about one or more periods of non-activity from said timing information; wherein said controlling module is arranged for configuring said wireless communication subsystem to perform said Listen-Before-Talk measurement in coordination with said one or more periods of non-activity; and wherein said controlling module is arranged for instructing said wireless communication subsystem to perform said Listen-Before-Talk measurement to identify said one or more unoccupied radio frequency sub-bands.

41. Terminal device according to claim 40, wherein said controlling module is a controlling module for enabling Listen-Before-Talk measurement to allow identifying of one or more unoccupied radio frequency sub-bands applicable for radio frequency identification (RFID) communication operable with a radio frequency identification (RFID) reader subsystem; wherein said controlling module is operable to exercise control over a wireless communication subsystem and said radio frequency identification (RFID) reader subsystem; wherein said controlling module is arranged for obtaining timing information relating to one or more periods of activity of said wireless communication subsystem therefrom; wherein said controlling module is configured to derive information about one or more periods of non-activity from said timing information; wherein said controlling module is arranged for configuring said wireless communication subsystem to perform said Listen-Before-Talk measurement in coordination with said one or more periods of non-activity; and wherein said controlling module is arranged for instructing said wireless communication subsystem to perform said Listen-Before-Talk measurement to identify said one or more unoccupied radio frequency sub-bands.

42. Terminal device according to claim 40, wherein said wireless communication subsystem is at least one of a cellular communication subsystem, a Bluetooth subsystem, or an IEEE 802.xx based subsystem.

43. Terminal device according to claim 42, wherein said cellular communication subsystem is at least enabled for GSM (Global System for Mobile Communication) based communication, in particular for multi-band GSM (Global System for Mobile Communication) based communication comprising at least GSM 850 conform operation.

44. Terminal device according to claim 40, wherein said radio frequency sub-bands are located in an ultra-high frequency band, in particular within a frequency range from 860 MHz to 960 MHz.

45. Terminal device according to claim 40, wherein said ultra-high frequency band is defined in accordance with frequency allocation of the ETSI (European Telecommunications Standards Institute) for radio frequency identification (RFID) communication at ultra-high frequency band.

46. System for enabling Listen-Before-Talk measurement to allow identifying of one or more unoccupied radio frequency sub-bands applicable for radio frequency identification (RFID) communication operable with a radio frequency identification (RFID) reader subsystem, said system comprising at least a wireless communication subsystem and said radio frequency identification (RFID) reader subsystem, wherein a controlling module of said system is operable to exercise control over a wireless communication subsystem and said radio frequency identification (RFID) reader subsystem; wherein said controlling module is arranged for obtaining timing information relating to one or more periods of activity of said wireless communication subsystem therefrom; wherein said controlling module is configured to derive information about one or more periods of non-activity from said timing information; wherein said controlling module is arranged for configuring said wireless communication subsystem to perform said Listen-Before-Talk measurement in coordination with said one or more periods of non-activity; and wherein said controlling module is arranged for instructing said wireless communication subsystem to perform said Listen-Before-Talk measurement to identify said one or more unoccupied radio frequency sub-bands.

47. System according to claim 46, wherein said controlling module is a controlling module for enabling Listen-Before-Talk measurement to allow identifying of one or more unoccupied radio frequency sub-bands applicable for radio frequency identification (RFID) communication operable with a radio frequency identification (RFID) reader subsystem; wherein said controlling module is operable to exercise control over a wireless communication subsystem and said radio frequency identification (RFID) reader subsystem; wherein said controlling module is arranged for obtaining timing information relating to one or more periods of activity of said wireless communication subsystem therefrom; wherein said controlling module is configured to derive information about one or more periods of non-activity from said timing information; wherein said controlling module is arranged for configuring said wireless communication subsystem to perform said Listen-Before-Talk measurement in coordination with said one or more periods of non-activity; and wherein said controlling module is arranged for instructing said wireless communication subsystem to perform said Listen-Before-Talk measurement to identify said one or more unoccupied radio frequency sub-bands.

48. System according to claim 46, wherein said wireless communication subsystem is at least one of a cellular communication subsystem, a Bluetooth subsystem, or an IEEE 802.XX based subsystem.

49. System according to claim 48, wherein said cellular communication subsystem is at least enabled for GSM (Global System for Mobile Communication) based communication, in particular for multi-band GSM (Global System for Mobile Communication) based communication comprising at least GSM 850 conform operation.

50. System according to claim 46, wherein said radio frequency sub-bands are located in an ultra-high frequency band, in particular within a frequency range from 860 MHz to 960 MHz.

51. Terminal device according to claim 46, wherein said ultra-high frequency band is defined in accordance with frequency allocation of the ETSI (European Telecommunications Standards Institute) for radio frequency identification (RFID) communication at ultra-high frequency band.
